(19) United States
(12) Patent Application Publication
(10) Pub. No.: US 2007/0178788 A1
(43) Pub. Date: Aug. 2, 2007

(54) Elastic Fire Blocking Materials

(75) Inventors: Eberhard Link, Raleigh, NC (US); Charles R. Mason, Nashua, NH (US); Amelia Tosti, Durham, NC (US); James Frasch, Hollis, NH (US); Ashutosh P. Karnik, Andover, MA (US)

Correspondence Address: FREUDENBERG NONWOVENS L. P., 3440 INDUSTRIAL DRIVE, DURHAM, NC, 27704, US

(73) Assignee: Freudenberg Nonwovens, L.P., Durham, NC (US)

(21) Appl. No.: 11/608,069

(22) Filed: Dec. 7, 2006

Related U.S. Application Data
(60) Provisional application No. 60/748,259, filed on Dec. 7, 2005.

(51) Int. Cl. B32B 27/12; D04H 13/00; D04H 1/46; B32B 27/04; B32B 5/02

(52) U.S. Cl. 442/136; 428/920; 428/921; 442/402; 442/328; 442/361; 442/414; 442/415

(57) ABSTRACT

The present invention relates to elastic fire blocking materials. The elastomeric material may be disposed on, impregnated into or intermingled with one or more layers of fire blocking material. These materials may be applied in, for example, mattresses or upholstery.

### CROSS REFERENCE To RELATED APPLICATIONS

The present application claims the benefit of the filing date of U.S. Provisional Application Ser. No. 60/748,259 filed Dec. 7, 2005, the teachings of which are incorporated herein by reference.

### FIELD OF INVENTION

The present invention relates to elastic fire blocking material composites and a method of making thereof. The composite material may include an elastomeric material disposed on, impregnated into or intermingled with one or more layers of fire blocking material. The materials may be applied in, for example, mattresses or upholstery.

### BACKGROUND

As noted in U.S. Pat. No. 6,287,690, it is well known in the textile industry to produce fire resistant fabrics for use as upholstery, mattress ticking, panel fabric, etc., using yarn formed of natural or synthetic fibers, and then treating the fabric with fire retardant chemicals. Conventional fire retarding chemicals include halogen-based and/or phosphorous-based chemicals. Such treated fabrics reportedly are heavier than similar types of non-fire retardant fabrics, and are said to have a more limited wear life.

For example, the incidence of mattress fires in the United States is such that there have been efforts to establish standards for testing open flame flammability of mattresses. California, e.g., has enacted regulations in 2001 which requires all mattresses to be sold effective January 2005 to meet the performance requirements of California Technical Bulletin 603. This is a consequence, among other things, of the fact that the foam used in mattresses can be a source of fuel which can be ignited and quickly engulf the mattress in flames.

Not surprisingly, therefore, one can uncover numerous disclosures aimed at modifying the burning characteristics of fiber materials. For example, in U.S. Pat. No. 4,600,606 a method of flame retarding textile and related fibrous materials is reported, which relies upon the use of a water-insoluble, non-phosphorous containing brominated aromatic or cycloaliphatic compounds along with a metal oxide. U.S. Pat. No. 4,026,808 reports on the use of a phosphorous containing N-hydroxy-methyl amide and tetrakis(hydroxymethyl)phosphonium chloride. U.S. Pat. No. 3,955,032 confirms the use of chlorinated-cyclopentadieno compounds, chlorobrominated-cyclpentadieno compounds, either alone or in combination with metal oxides.

U.S. Pat. No. 4,702,861 describes a flame retardant composition for application as an aqueous working dispersion onto surfaces of combustible materials. Upon exposure to elevated temperatures and/or flame, the formulation reportedly creates a substantially continuous protective film generally encapsulating and/or enveloping the surface of the article onto which it is applied. The film-forming materials are based upon an aqueous latex dispersion of polyvinylchloride-acrylic copolymer together with certain other film-forming and viscosity controlling components.

Other disclosures which offer additional background information include U.S. Pat. No. 4,776,854 entitled “Method for Flameproofing Cellulosic Fibrous Materials”; U.S. Pat. No. 5,051,111 entitled “Fibrous Material”; U.S. Pat. No. 5,569,528 entitled “Treating Agent for Cellulosic Textile Material and Process for Treating Cellulosic Textile Material”; and U.S. Pat. No. 6,309,565 entitled “Formaldehyde-Free Flame Retardant Treatment for Cellulose-Containing Materials”.

It is also worth mentioning that within the various efforts to provide flame resistant fabric products, various polymers themselves have emerged as substrates for use as flame resistant fibers. For example, melamine and melamine/formaldehyde based resinous fibers are said to display desirable heat stability, solvent resistance, low flammability and high-wear characteristics. One form of melamine/formaldehyde fiber is marketed under the trade name Basofil™. In addition, the aromatic polyamide family or aramids reportedly have high strength, toughness, and thermal stability. Aramid fibers are marketed under the trade names Nomex™ and Kevlar™.

Furthermore, acrylic fibers are well-known in the synthetic fiber and fabric industries, as are the modified acrylic fibers (modacrylic). Such modacrylics are relatively inexpensive, and have been used in various blends with the fibers noted above to provide fire-resistant fabric material. One particular modacrylic fiber is sold under the trade name Kanecaron™ Protex, which is available from Kaneka Corporation, Japan.

In addition, flame retardant viscose fibers have become available, and one particular viscose fiber is sold under the trade name Visil™. More specifically, Visil™ is said to comprise a silicic acid containing viscose, with a limiting oxygen index (i.e., the minimum concentration of oxygen necessary to support combustion) in the range of 27-35, depending upon a particular textile construction.

### SUMMARY

The present invention relates to an elastic fire blocking composite comprising a composite of a non-woven needle-punched fire blocking material and an elastomeric material wherein the composite stretches between 1-60% and recovers about 85-100%.

### DETAILED DESCRIPTION

The present invention relates to elastic fire blocking materials and methods of making thereof. The elastic fire blocking material may include a fire blocking material which includes elastic material disposed on, intermingled with or impregnated therein.

The flame retardant materials may include nonwoven, woven or knit fabric. The fabrics may be composed of fibers or yams including, for example, modacrylics, viscose fibers, aramid fibers, cellulosic fibers, regenerated cellulose fibers, melamine/formaldehyde fiber, polyester fibers, polyolefin fibers, or natural fibers such as cotton, wool, etc. Binder materials, such as binder fibers and or a binder layer may also be incorporated into the fire blocking materials herein. Additionally, inorganic fillers may be used to coat or saturate the flame retardant materials, providing additional fire blocking characteristics.

Modacrylic fiber may be based upon a polyacrylonitrile copolymer with a halogen containing comonomer. The halogen containing comonomer may include for example poly(vinyl chloride) or poly(vinylidine chloride). An exemplary modacrylic fiber is available form Kaneka Corporation, under the trade name Kanecaron™ Protex. In particular, the modacrylic employed herein is sold under the trade name Kanecaron™ Protex PBX, at a specific gravity of 1.45-1.60 with a fiber denier of 2.2 dtex×38 mm. Protex PBX is described as having the following chemical components: acrylonitrile, vinylidine chloride copolymer, antimony oxide. An exemplary melamine/formaldehyde fiber component is sold under the trade name Basofil™, available from McKinnon-Land-Moran, LLC.

Cellulosic fiber is a general reference to a viscose or regenerated cellulose fiber as well as natural cellulosic fibers. Viscose fiber is a general reference to a fiber produced by the viscose process in which cellulose is chemically converted into a compound for ultimate formation into a fiber material. An exemplary viscose containing silicic acid is sold under the trade name Visil™, available from Sateri Oy Inc. The Visil fiber may be type AP 33 3.5 dtex×50 mm. It is composed of 65-75% regenerated cellulose, 25-35% silicic acid, and 2-5% aluminum hydroxide.

Regenerated cellulose is general reference to cellulose that is first converted into a form suitable for fiber preparation (e.g. xanthation) and regenerating the cellulose into fiber form. The regenerated cellulose fiber may be prepared from wood pulp, e.g. lyocell fiber. Lyocell fiber is broadly defined herein as one example of a synthetic fiber produced from cellulosic substances. Lyocell is reportedly obtained by placing raw cellulose in an amine oxide solvent, the solution is filtered, extruded into an aqueous bath of dilute amine oxide, and coagulated into fiber form. From a property perspective, lyocell is also described as being a relatively soft, strong and absorbent fiber, with excellent wet strength, that happens to be wrinkle resistance, dyable to a number of colors, simulating silk or suede, with good drapability.

Natural cellulosic fibers may include, e.g., cotton, ramie, kenaf, flax, etc.

The fibers herein (e.g., natural cellulose or regenerated cellulose) may be treated with a fire retardant additive, such as a phosphorous compound or a halogen compound or an antimony compound. Exemplary phosphorous compounds include organic phosphates, phosphoric acid esters, and quaternary phosphonium compounds. It may also be appreciated that the level of any such fire retardant additive may be in the range of 5-30% by weight with respect to a given fiber, including all values and ranges therein. For example, one particularly useful range of fire retardant additive may be between about 10-15% by weight. Furthermore, with respect to the actual treatment of the fibers herein with such fire retardant additive, it may be appreciated that the additive may be applied to a fiber alone (e.g., to the natural cellulose fiber or viscose fiber) or even to the web that may ultimately contain the cellulose fiber in combination with other fiber components.

Aramid fiber is reference to an aromatic polyamide type fiber material, such as a poly (p-phenylene terephthalamide) made by E.I. DuPont de Nemours & Co. and sold as KEVLAR®. Aramid fiber may also be a reference to an aromatic polyamide type fiber material, such as poly (m-phenyl terephthalamide) made by E.I. DuPont de Nemours & Co., sold number the trade name Nomex®. Aramid fiber may also be available from Teijin under the trade name Twaron™.

The binder may include polymer binder fiber incorporated in the layers of the non-woven textile or added as a layer in between layers of materials described herein. The binder may be in the form of a powder, web, or fibers. Fibers may be in the form of a sheath/core, side-by-side, or monofilament configuration.

The binder fibers of the present invention may include one or a plurality of polymer components. Binder fibers may be, for example, 4d×2″ from either Nan Ya or Sam Yang in Korea with the outer layer having a melting point of 150° C. which melting point is lower than the melting point of the inner layer of this particular binder fiber material. The binder fiber outer layer may melt and flow onto the other fibers which bond the structure together.

The fabrics may be formed from one or more layers produced by combining one or more of the above mentioned fibers using a number of processing techniques to form a non-woven, woven or knit fabric. Non-woven processing techniques may include mechanical intermingling, fusing or bonding of the fibers. Examples of mechanical intermingling include needle punching, carding, spunbonding, spunlacing, vertical lapping, etc. Exemplary methods of fusion or bonding may include the use of thermoplastic binder fibers, or mediums which bond the fibers together such as starch, casein, latex, cellulose derivatives or synthetic resin. Knitting techniques may include for example, warp knitting and circular knitting.

Furthermore, inorganic fillers may be included as a coating on the fabrics or in individual fabric layers. Inorganic fillers may include, for example, vermiculite, graphite, fumed silica or silica dioxide, or titanium dioxide, and mixtures thereof. Vermiculite, for example, is reference to one of the mica groups that may be used as granular fillers, and comprises a crystalline layer silicate material. However, some of the silicon atoms may be replaced with aluminum, producing a negative charge that is neutralized by the interlayer cations, mostly magnesium. The vermiculite particles may be of a planar structure consisting of platelets that have a minimum 400:1 xy plane to z plane ratio. The level of vermiculite herein, as a coating in the fabric, is about 20-40 g/m², including all increments therebetween at 1.0 g/m² variation.

As alluded to above, the flame retardant material may be composed of a variety of the materials and fiber components discussed herein. In one exemplary embodiment, the flame retardant material may be a nonwoven textile structure composed of a first fiber component of modacrylic fibers and a second fiber component of either viscose fiber containing silicic acid, regenerated cellulose fiber and/or a melamine/formaldehyde fibers. A third fiber component may also be included of either aramid fiber, melamine/formaldehyde fiber, polyester fiber, natural fibers or mixtures thereof. Additionally binder may be included. The structure may be, for example, needle punched, or when binder is present vertically lapped and bonded.

In another embodiment, the flame retardant material may be composed of a web of aramid fiber attached to a support material or a web of polyacrylonitrile copolymer with a halogen monomer and polyester by intermingling, such as needlepunching. The aramid fibers may include one or both of para-aramid or meta-aramid fibers. The aramid fiber component may also include polyacrylonitrile copolymer with a halogen containing monomer, melamine/formaldehyde fiber and/or viscose fiber containing silicic acid.

In another exemplary embodiment, the flame retardant component of the fabric may include cellulosic fiber, modacrylic fiber and polyester fiber needlepunched together. The cellulosic fiber may be present between about 20 to 80% by weight of the fabric including all increments and values therebetween, the modacrylic fiber may be present between about 20 to 80% by weight of the fabric including all increments and values therebetween and the polyester fiber may be present between 1 to 60% by weight of the fabric including all increments and values therebetween.

It may therefore be understood that the cellulose fibers (e.g. a viscose cellulose fiber such as Visil™ or natural cellulosic fiber containing a flame retardant additive) may be combined with one or a plurality of other various fibers. These other fibers may include, e.g., polyester, wool, cashmere or even polyimide type fiber material. The cellulose fibers may therefore be present in an amount of about 100%-30% (wt) the other fibers may be present in an amount of about 0-70%, to form a given web.

In a further exemplary embodiment, the flame retardant component of the fabric may include a first layer of cellulosic fiber and aramid fiber, and a second layer of polyacrylonitrile copolymer with a halogen comonomer fiber and polyester fiber. In the first layer the cellulosic fiber may be present between about 50 to 99% by weight of the layer including all increments and values therebetween and the aramid fiber may be present between about 1 to 50% by weight of the layer including all increments and values therebetween. In the second layer, the polyacrylonitrile copolymer with a halogen comonomer fiber may be present between about 40 to 90% by weight of the layer and all increments and values therebetween and the polyester may be present between about 10 to 60% by weight of the layer and all increments and values therebetween.

The fire blocking fabrics may also include a one or more supporting layers. The supporting layers may be composed of mattress ticking, polyolefin or polyester spunbond webs or polyester/polyamide blends. The mattress ticking may be cotton, cotton/polyester, rayon/polyester, rayon/cotton/polyester, rayon/cotton polypropylene, rayon/polypropylene blends or about 100% polypropylene or polyolefins. The mattress ticking may be nonwoven or woven. Furthermore, the mattress ticking may be impregnated with a binder, including for example acrylic binders.

In addition, preferably, the fiber denier of the fibers of such textile structure may be configured in the range of about 1-15 denier, including all increments and ranges therebetween. The fabrics contemplated herein may exhibit a weight of between about 20 grams per square meter and 500 grams per square meter including all increments or values therebetween, including 50 grams per square meter, 100 grams per square meter, 350 grams per square meter etc. The fabrics contemplated herein may also exhibit a density of between about 10 kilograms per cubic meter and 175 kilograms per cubic meter including all increments or values therebetween, including 30 kilograms per cubic meter, 50 kilograms per cubic meter, etc. Furthermore, the fabrics may be between 1 mm and 10 mm in thickness including all increments and values therebetween, e.g. 2 mm, 3 mm, 5 mm, etc, plus or minus 0.01 mm.

The elastic materials contemplated herein may include materials that exhibit recovery when a mechanical stress, such as stretching, is placed on the material. Elastic materials used herein may include for example, elastomeric polymers, such as polyurethane, chloroprene, etc. Polyurethane may include spandex fiber which may be understood to include segmented polyurethane. Spandex may be available from Dorlastan Fibers under the trade name Dorlastan or from Invista under the trade name Lycra. Polychloroprene may be understood herein to be a type of synthetic rubber. Polychloroprene may be available from E.I. DuPont de Nemours under the name neoprene. Other elastomeric type polymers may include polyisoprene, polybutadiene, polystyrene-butadiene and silicones.

The elastic materials may be impregnated into, disposed or sprayed on, or intermingled with fire blocking materials. For example, a fire blocking fabric containing one or more layers may be impregnated by a polymer dispersion of an elastomeric material. The dispersion may generally be understood herein as polymer suspended in a diluent. The diluents may include surfactants to maintain the stability of the polymer in the dispersion. The diluent may be solvent based or aqueous based and furthermore may be volatile. When the diluent evaporates, the polymer molecules may form a film. If the particles are not already above the glass transition temperature, it may then be necessary to heat the particles above the glass transition temperature to form a solid continuous polymeric phase about the fibers in the fire blocking fabric.

The elastomeric materials may also be disposed on the fire blocking materials via a process such as lamination or printing. The elastic material may be disposed on one or both side of the fabric, or the individual layers of the fabric where one or more layers are present. Lamination may be accomplished, for example, by heat bonding, point pointing or ultrasonic bonding of an elastic material to the fire blocking material. The elastomeric material may be a continuous fiber, which may be formed into a net or the elastic material may be in the form of a continuous sheet.

Elastic polymer material may also be printed on the surface of a fire blocking fabric using continuous lines or patterns. The elastic polymer material may be deposited in the form of a dispersion, as discussed above, or in the form of a melt, which may solidify once deposited. It is also contemplated that the elastic polymer material may be deposited in melt form and optionally cross linked upon exposure to heat or radiation.

Furthermore the elastic material may be mechanically affixed to fire blocking materials through processes such as needlepunching or knitting the elastomeric material with the fire blocking material. For example, the elastomeric material in the form of fibers, net or sheet may be needle punched to one or more layers of a fire blocking material. The elastomeric material may also be knit into the fire blocking material by, for example, warp knitting via use of a warp-knitting machine.

The elastic fire blocking composite may include for example, between about 30 to 99% by weight of the fire blocking material including all increments and values therebetween and between about 1% to 70% of the elastic material, including all increments and values therebetween. Weight percentages of the elastic material and the fire blocking material may be varied, along with the final basis weight to provide desired flame resistance and elasticity.

The elastic fire blocking composites may be stretched up to and greater than about 1 to 60% of the initial length of the composite material and any increments and values therebetween including 25%, 26%, etc. Depending upon the amount the composite is stretched, recovery may be between about 85-100% including all increments and values therebetween. In addition, the composites herein may be repeatedly stretched to the indicated levels and repeatedly recovered within the range of about 85-100% including all values and increments between about 85-100%.

Expanding upon the above, it can be appreciated that the elastic fire blocking material herein, when applied to a mattress or other similar surface, that has elasticity, may be able to substantially match the elasticity and recovery characteristics of such surface and stretch and recover without substantial buckling. Accordingly the elastic fire blocking composite herein may stretch and recover in a manner that is substantially equal to the stretch and recovery of mattress material, such as foam. In addition, should the mattress include a layer of material (ticking) that is capable of stretch and recovery, the elastic fire blocking material is capable of a stretch and recovery that is substantially equal to the stretch and recover of such layer of material.

The foregoing description is provided to illustrate and explain the present invention. However, the description hereinabove should not be considered to limit the scope of the invention set forth in the claims appended here to.

What is claimed is:

1. A elastic fire blocking composite comprising:
a composite of a non-woven needle-punched fire blocking material and an elastomeric material wherein said composite stretches between 1-60% and recovers about 85-100%.

2. The composite of claim 1 wherein said fire blocking material comprises:
a first fiber component containing polyacrylonitrile copolymer with a halogen containing monomer; and
a second fiber component comprising viscose fiber containing silicic acid, regenerated cellulose fiber or melamine/formaldehyde fiber.

3. The composite of claim 2 wherein said fire blocking material further comprises a third fiber component comprising aramid fiber, melamine/formaldehyde fiber, polyester fiber or natural fiber.

4. The composite of claim 1 wherein said fire blocking material comprises
a first web including aramid and/or melamine/formaldehyde fiber and
a second web comprising a blend of polyacrylonitrile copolymer with a halogen comonomer and a polyester polymer, wherein said first web including aramid and/or melamine formaldehyde fiber is intermingled with said second web of said blend.

5. The composite of claim 4 wherein said first web further comprises cellulosic fiber.

6. The composite of claim 4 wherein said first web and said second web are carded.

7. The composite of claim 4 wherein said first web and said second web are needlepunched.

8. The composite of claim 1 wherein said elastomeric material is selected from the group consisting of polyurethane, styrene-butadiene polymers, or neoprene.

9. The composite of claim 1 wherein said elastomeric material is present between about 1 to 70% by weight of the composite and said fire blocking material is present between about 30 to 99% by weight of the composite.

10 The composite of claim 1 further comprising an inorganic filler.

11. The composite of claim 1 wherein said non-woven needle-punched fire blocking material comprises non-woven fibers including a fire retardant additive.

12. The composite of claim 1 wherein said non-woven needle-punched fire blocking material comprise cellulose fibers present in an amount of about 30% to about 100% by weight and optionally, a second fiber component, present in an amount of about 0-70% by weight.

13. A method for producing an elastic fire blocking composite comprising:
providing a non-woven needle-punched fire blocking material;
providing an elastomeric material;
affixing said elastomeric material to said fire blocking material to form a composite.

14. The method of claim 13 wherein said elastomeric material is provided in a dispersion and said step of affixing comprising impregnating said fire blocking material with said elastomeric material.

15. The method of claim 13 wherein said step of affixing comprises laminating said elastomeric material to said fire blocking material.

16. The method of claim 15 wherein said lamination comprises heat bonding.

17. The method of claim 13 wherein said step of affixing comprising printing said elastomeric material onto said fire blocking material.

18. The method of claim 13 wherein said step of affixing comprises needlepunching said elastomeric material to said fire blocking material.

19. The method of claim 13 wherein said step of affixing comprises knitting said elastomeric material with said fire blocking material.

20. The method of claim 13 wherein said step of affixing comprises spraying said elastomeric material onto said fire blocking material.

21. The method of claim 13 wherein said non-woven needle-punched fire blocking material comprises non-woven fibers including a fire retardant additive.

22. The method of claim 13 wherein said non-woven needle-punched fire blocking material comprise cellulose fibers present in an amount of about 30% to about 100% by weight and optionally, a second fiber component, present in an amount of about 0-70% by weight.

23. A mattress comprising an elastic non-woven needle punched fire blocking material.

24. The mattress of claim 23 wherein said mattress includes material or a layer of material that is capable of stretch and recovery and said elastic fire blocking material is capable of matching said stretch and recovery of said mattress material or layer of mattress material.
